(19) United States
(12) Patent Application Publication
(10) Pub. No.: US 2025/0026063 A1
(43) Pub. Date: Jan. 23, 2025

(54) CONTAINER PROCESSING SYSTEM FOR PRODUCING CONTAINERS FROM PREFORMS

(71) Applicant: Krones AG, Neutraubling (DE)

(72) Inventors: Norbert KINDL, Tegernheim (DE); Florian NEBL, Mintraching (DE); Florian GELTINGER, Donaustauf (DE); Andreas ROTH, Erlangen (DE); Christian KILLERMANN, Roetz (DE); Dieter WUENSCHE, Straubing (DE)

(21) Appl. No.: 18/777,232

(22) Filed: Jul. 18, 2024

(30) Foreign Application Priority Data
Jul. 19, 2023 (DE) 102023119051.2

(51) Int. Cl. B29C 49/42; B29C 49/64; B29C 49/78

(52) U.S. Cl. CPC B29C 49/42065; B29C 49/6418; B29C 49/78; B29C 2049/7876

(57) ABSTRACT

A container processing system, the container processing system comprising a production machine for producing preforms, in particular an injection molding machine, a heating device for heating preforms, a blow molding machine for molding preforms into containers, a first transport device for transporting preforms along a first transport direction to the heating device and a second transport device for transporting heated preforms from the heating device to the blow molding machine, wherein the container processing system occupies a fictitious base area in the shape of a rectangle and the production machine, the heating device and the blow molding machine each occupy a fictitious component base area in the shape of a rectangle, wherein a longest side of the base area has a length that is smaller than the sum of the longest sides of the component base areas and the length of the first and the second transport device.

### CROSS REFERENCE TO RELATED APPLICATION

The present application claims priority to German Patent Application No. 10 2023 119 051.2 filed on Jul. 19, 2023. The entire contents of the above-listed application are hereby incorporated by reference for all purposes.

### TECHNICAL FIELD

The present disclosure relates to a container processing system for producing containers from preforms.

### BACKGROUND

Container processing systems are sufficiently known from the prior art. They usually comprise a series of machines which can be synchronized with one another in terms of their container throughput and between which the preforms and/or containers can be transported by means of one or more transport devices (for example, linear conveyor devices or transport stars). Preforms are usually fed to the container processing systems via sorting devices, wherein the preforms are customarily obtained from a preform producer so that they are fed to the container processing system as “bulk material” and introduced into the container processing system by means of the sorting device.

### SUMMARY

This requires a spatial and temporal separation of the production of the preforms on the one hand and the further processing of the preforms into containers on the other hand. This entails disadvantages in terms of a deterioration in the quality of the preforms during their storage and any sterility requirements that the preforms or the containers produced therefrom necessarily have to meet, which complicates the further processing of the preforms.

On the other hand, a goal of the prior art is to keep the space requirement of container processing systems as small as possible.

### Problem

Proceeding from the known prior art, the technical object to be achieved is thus to make the production of containers from preforms and their further processing as efficient as possible and at the same time to keep the necessary space requirement of a container processing system as small as possible.

### Solution

This object is achieved by the container processing system as described herein.

The container processing system according to the disclosure for producing containers from preforms comprises a production machine, in particular an injection molding machine, for producing preforms, a heating device for heating preforms, a blow molding machine for molding preforms into containers, a first transport device for transporting preforms along a first transport direction to the heating device and a second transport device for transporting heated preforms from the heating device to the blow molding machine, wherein the container processing system occupies a fictitious base area in the shape of a rectangle and the production machine, the heating device and the blow molding machine each occupy a fictitious component base area in the shape of a rectangle, wherein a longest side of the base area has a length that is smaller than the sum of the longest sides of the component base areas and the length of the first and the second transport device.

According to the disclosure, any machine suitable for producing preforms can be used as the production machine. In particular, the production machine can be designed as an injection molding machine or comprise such a machine. However, other embodiments in which the preforms are produced from a solid and/or partially liquid or liquefied starting material are also conceivable. For example, as an alternative to an injection molding machine, a compression molding machine or injection compression molding machine may also be used as the production machine.

The term “fictitious base area” is understood to mean an imaginary base area occupied by the container processing system. This imaginary base area can, for example, represent the smallest possible rectangle into which the container processing system can be fictitiously installed. The same applies to the fictitious component base areas, which can likewise be assumed to be rectangles and are optionally designed such that one of the sides of the component base area coincides with or runs parallel to an outlet or an inlet for preforms or containers of the corresponding machine (i.e., the blow molding machine, the production machine and the heating device).

The transport devices can be designed as desired and can in particular comprise conveyor devices, for example for the hanging transport of the containers along a linear, optionally straight path, and/or one or more transport stars. In this sense, the first and second transport directions are respectively to be understood as the transport direction of the containers which runs tangentially to the respective transport device at a point of transfer of the preforms and/or containers from one of the machines (blow molding machine, production machine or heating device) to the transport device or from the transport device to one of the respective machines.

The arrangement of the machines of the container processing system and of the transport devices allows a structure of the container processing system that is as space-saving as possible with a simultaneously short transport distance for the preforms and/or containers between the individual machines. This achieves a space-saving integration of the production machine into the container processing system, whereby the hygienic requirements for the production of the containers can be met more easily at the same time.

A further container processing system according to the disclosure for producing containers from preforms comprises a production machine, in particular an injection molding machine, for producing preforms, a heating device for heating preforms, an aseptic block for aseptically producing containers from the preforms and for aseptically filling and closing containers, a first transport device for transporting preforms along a first transport direction to the heating device and a second transport device for transporting heated preforms from the heating device to the aseptic block, wherein the container processing system occupies a fictitious base area in the shape of a rectangle and the production machine, the heating device and the aseptic block each occupy a fictitious component base area in the shape of a rectangle, wherein a longest side of the base area has a length that is smaller than the sum of the longest sides of the component base areas and the length of the first and the second transport device.

With respect to the fictitious component base area and the base area as well as the transport devices, what has already been described with regard to the previous embodiment applies. This design of the container processing system also makes possible a space-saving realization of aseptic processing of containers with an integrated production machine.

It may be provided that the aseptic block comprises an aseptic chamber and a blow molding machine arranged therein for forming the preforms into containers, a filling machine arranged downstream of the blow molding machine for filling the containers, and a closer arranged downstream of the filling machine for closing the containers.

The aseptic chamber may be a chamber in which certain hygienic or other physical requirements (air humidity, number of contaminant particles in the air per cubic meter, temperature, or the like) are achieved. In this sense, it can represent a kind of clean room. By arranging the blow molding machine, the filling machine and the closer in the aseptic chamber, a closed process is realized for the production and further processing of the containers up to closing, which can meet hygienic requirements. The aseptic chamber or its outer boundary can, but does not have to, be identical to the fictitious component base area.

In one embodiment, it is provided that the shortest side of the base area has a second length that is smaller than the sum of the shortest sides of the component base areas and the length of the first and the second transport device. This compactifies the container processing system.

An outlet of the production machine can enclose an angle between 0° and 90° or between 30° and 60° with the first transport direction. This achieves an efficient and space-saving arrangement of the production machine and the transport device.

An inlet of the heating device can enclose an angle between 0° and 90° or between 30° and 60° with the first transport direction. With this embodiment, an efficient, in particular space-saving arrangement of the production machine and the heating device can be realized.

It may be provided that an outlet of the heating device encloses an angle between 0° and 90° or between 30° and 60° with the second transport direction. Further compactification of the heating device, the production machine and the blow molding machine or the aseptic block is thereby realized.

The container processing system may furthermore comprise a sorting device for removing and aligning preforms from a supply, and the sorting device can feed aligned preforms to an outlet of the production machine, wherein a transport direction of the preforms from the sorting device to the outlet can optionally be parallel to a transport direction of preforms within the production machine to the outlet. Should the production machine fail, an alternative feed of preforms can thereby be realized in a space-saving manner.

It may be provided that the sorting device is arranged at a higher height level than the production machine and, when viewed in a direction perpendicular to the component base area of the production machine, is arranged at least partially overlapping with the production machine. This design further compactifies the container processing system.

A switch, with which a feeding of preforms from the production machine or the sorting device can be controlled, can be arranged upstream of the outlet. This allows for flexible switching between the different options for feeding preforms.

It may be provided that the production machine comprises an inspection device for inspecting preforms. This embodiment ensures the quality of the produced preforms for use in the blow molding machine.

The production machine may comprise a removal device for removing produced preforms from a tool of the production machine, and the removal device may feed the preforms to an outlet of the production machine, or to the first transport device, or to a receptacle depending on an inspection result.

With this embodiment, preforms of insufficient quality can be sorted out before they are fed to downstream devices of the container processing system.

### BRIEF DESCRIPTION OF THE FIGURES

FIG. 1 shows an exemplary container processing system

FIG. 2 shows an embodiment of a container processing system

FIG. 3 shows an embodiment of a production machine and a sorting device

FIG. 4 shows another embodiment of a container processing system with an aseptic block

### DETAILED DESCRIPTION

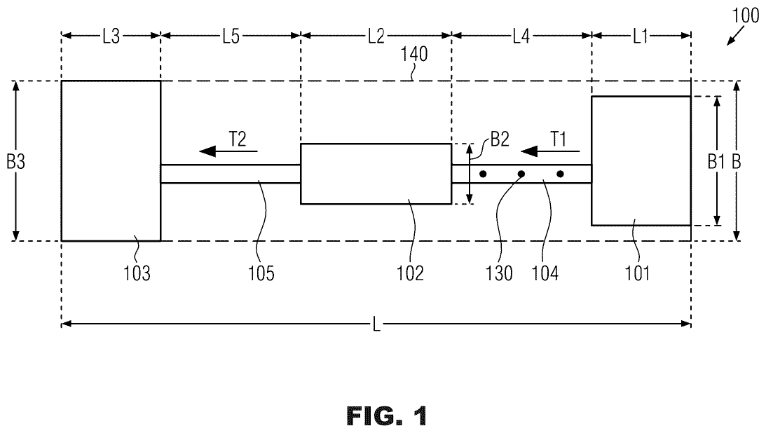

FIG. 1 shows an example of a container processing system 100, which is not the subject matter of the disclosure. The container processing system 100 comprises a production machine 101. In said production machine, preforms can be produced from starting material (for example, plastics pellets). The production machine can, for example, be or comprise an injection molding machine. However, other embodiments of the production machine are also conceivable.

From the production machine, the preforms are fed via a first transport device 104 along a first transport direction T1 to a heating device 102. In this heating device 102, the preforms are heated to a desired temperature for subsequent molding and are conveyed from the heating device 102 by means of a transport device 105 along the second transport direction T2 to the blow molding machine 103. In said blow molding machine, they are formed into containers and can subsequently be processed further (for example, filled and closed).

The blow molding machine 103 can in particular be designed as a rotary machine with a series of blow molds on its periphery, which blow molds can receive preforms and mold them into a container (for example, by applying compressed air and/or by stretching with a stretching rod). The heating device can be designed as a linear conveyor line, which also comprises one or more turns with opposite transport direction of the preforms and, by applying heat to at least a portion of the surface of the preforms, can heat the preforms to a desired temperature in order to make subsequent molding possible.

The production machine 101 is assigned a fictitious component base area, which can be represented as a rectangle with the smallest surface area into which the production machine can be completely fitted. This rectangle has a longer side L1 and a shorter side B1, wherein L1 is greater than or equal to B1. If L1 is equal to B1, the rectangle is a square.

The first transport path 104 has a length L4, which at least partially bridges the distance between an inlet of the production machine 101, from which the preforms 130 are transferred to the first transport device 104, and an inlet of the heating device 102, in which the preforms are transferred from the first transport device 104 to the heating device 102. The length L4 may, but does not have to, be measured parallel to the first transport direction T1.

Analogously to the production machine 101, the heating device comprises a fictitious component base area in the shape of a rectangle with a longer side L2 and a shorter side B2. The second transport device 105 comprises a length L5 analogously to the length L4 and transports containers in the transport direction T2. Analogously to the previously described production machine and heating device, the blow molding machine 103 comprises a fictitious component base area in the shape of a rectangle with the side lengths L3 (longer side) and B3 (shorter side).

While the lengths L1, L2, L3 and L4 are parallel and L1, L2 and L3 have the same orientation in the view shown, this is only to be understood as an example.

In the arrangement shown here of the components of the container processing system 100, a fictitious base area 140 of the entire container processing system 100 can likewise be represented as a rectangle, which may be the rectangle with the smallest surface area into which the entire container processing system 100 can be fitted.

As can be seen, this rectangle comprises a longer side L and a shorter side B, wherein L and B can also be identical to one another (i.e., the fictitious base area forms a square). As shown in FIG. 1, the length L is composed of the sum of the lengths L1 to L5, i.e., it is equal to the sum of the longest dimensions of the production machine, the heating device and the blow molding machine and of the lengths of the first transport device 104 and the second transport device 105. This results in a considerable space requirement for the container processing system.

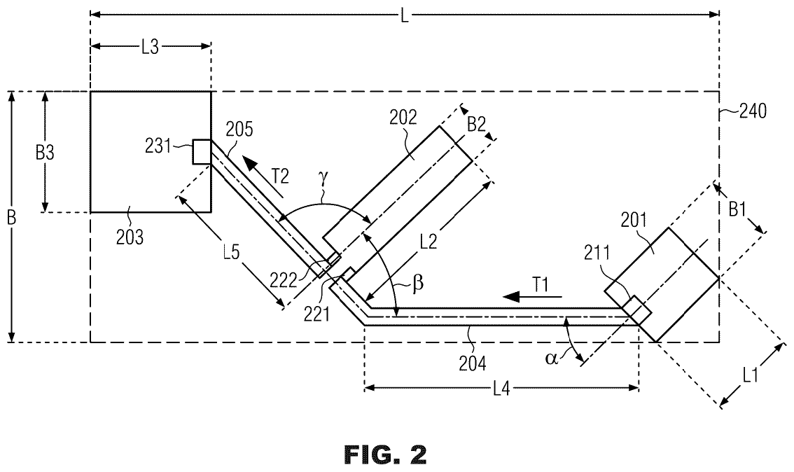

FIG. 2 shows an embodiment of a container processing system 200 according to the disclosure. Analogously to FIG. 1, the container processing system 200 in this embodiment comprises a production machine 201, a first transport device 204, a heating device 202, a second transport device 205 and a blow molding machine 203, which, analogously to the examples described in FIG. 1, have fictitious component base areas, which are each formed as a rectangle with the corresponding side lengths.

Furthermore, the container processing system 100 comprises a fictitious base area 240, which can be represented analogously to FIG. 1 as the rectangle with the smallest surface area into which the container processing system with the particular fictitious component base areas can be fitted.

However, in the embodiment of FIG. 2, the first and second transport devices 204 and 205 are connected to the production machine 201, the heating device 202 and the blow molding machine 203 such that the longer side of the fictitious base area 240 of the container processing system 200 has a length L that is smaller than the sum of the longer sides of the component base areas and the length of the transport devices L4 and L5.

This can be realized by suitable arrangements of the outlets 201 from the production machine or the connection to the first transport device 204 as well as suitable selection or arrangement of the inlet 221 of the heating device and the outlet 222 of the heating device as well as the relative arrangement of the first transport device 204 and the second transport device 205 relative to the inlet 221 and the outlet 222. In particular, it may be provided that an outlet of the production machine (in particular a transport direction of the containers or preforms from the production machine in the direction of the first transport device or a straight line tangential to this direction) encloses an angle between 0 and 90° with the transport direction T1 in the region of the outlet, thus in particular encloses an acute angle. The preforms are thus not transported from the production machine 201 in a straight direction (for example, parallel to a transport direction of the preforms near the production machine 201) but at an angle α. Said angle can be between 30° and 60°.

Analogously, an angle between the inlet 221, or a transport direction of the preforms in the inlet, and the first transport direction T1 (denoted by B) can likewise be an acute angle (optionally between 30° and) 60°. This makes it possible for the production machine 201 and the heating device 202 to be arranged at least partially side by side so that at least one side length of the rectangle enclosed by these components is shortened.

Analogously, an angle between the second transport direction T2 of the second transport device 205 and the outlet 21 of the heating device 201 (in particular an angle between the direction of movement of the preforms in the outlet 222 and the second transport device T2) can be an acute angle between 0 and 90°. Angles between 30° and 60° can also be provided here. This allows a more compact arrangement of the heating device relative to the blow molding machine so that a further shortening of the extension of the container processing system is achieved in at least one direction.

By means of a corresponding arrangement, it can furthermore be ensured that the shorter side B of the fictitious base area continues to be smaller than the sum of the shorter sides of the production machine 201, the heating device 202 and the blow molding machine 203 and of the lengths L4 and L5 of the first transport device and the second transport device.

The angles α, β and γ can be different in pairs but can also be identical, for example all 30° or all 50°. The disclosure is not limited in this respect.

So far, the production machine 201 has been described only generally as an apparatus that provides the preforms.

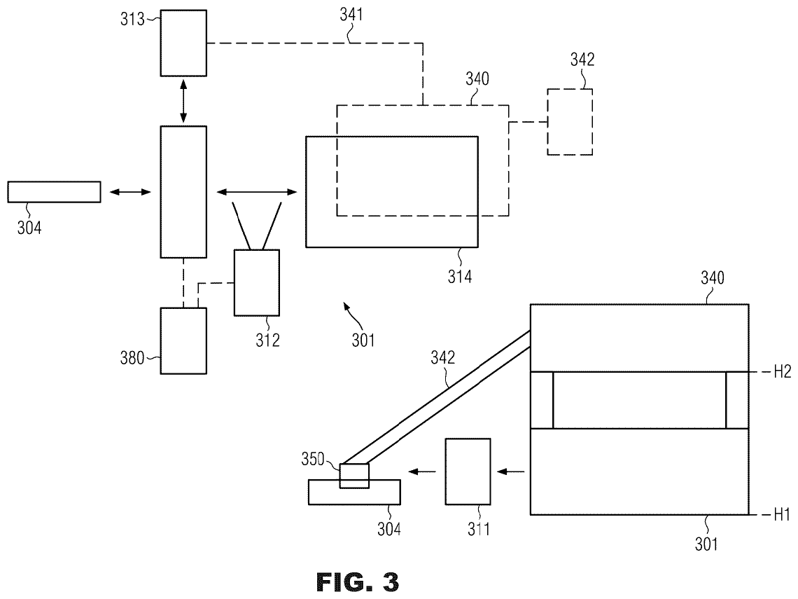

FIG. 3 schematically shows a further embodiment of the production machine as an injection molding machine. This embodiment can be combined with any of the above-described and below-described embodiments in such a way that, instead of the generally mentioned production machine, the injection molding machine described with reference to FIG. 3 can also be used.

In the embodiment shown here, the injection molding machine comprises a tool 314 in which the preforms are produced. The tool 314 may, for example, comprise a receptacle with a number of injection molds in a regular pattern, into which injection molds heated and in particular liquid preform material can be injected in order thus to produce preforms. The injection molding machine 301 can furthermore comprise a removal device 311, which can remove the preforms from the tool 314 and feed them to the first transport device 304 or to a transport device extending within the injection molding machine 301 to the transport device 304. Optionally, it may be provided that the injection molding machine 301 furthermore comprises an inspection device 312, which can inspect preforms either in the tool 314 and/or in the removal device 311. The inspection device 312 can be designed, for example, as a camera or other optical recognition device and can take images of preforms, which can then be transmitted, for example, to a control unit 380 of the injection molding machine 301 (which can be designed as a computer with an assigned processor and/or memory), in which the images are then evaluated in order to determine a quality of the preforms or an inspection result.

Determining the inspection result may, for example, consist of or comprise determining a transmittance of the material of the preform(s). Depending on the inspection result, it can then be provided that the control unit of the removal device 311 controls such that preforms whose inspection result indicates that further use of the preform, for example for molding the preform into a container, is possible are fed to the transport device 304 and preforms whose inspection result indicates that the quality of the preform is not sufficient for further use of the preform are fed to a receptacle 313 for preforms. In this receptacle, the preforms can either be held for later disposal, or they can also be reprocessed into preform material (for example, by comminution) and fed to the tool 314 for producing preforms.

Optionally, the injection molding machine 301 may furthermore comprise a sorting device, or a sorting device 340 may be assigned to the injection molding machine 301. The sorting device can be connected to a supply 342 of preforms and/or to the receptacle 313 for preforms (for example, via the transport device 341) and receive preforms as bulk material in order to align them and feed them to the transport device 304 or an outlet (see FIG. 2) of the injection molding machine. This may be provided in case the injection molding machine 301 fails or preforms are not provided for other reasons. The control unit 380 can then be designed to cause a feed of preforms via the sorting device.

Particularly, the sorting device (see FIG. 3) can be arranged at a height level H2 that is higher than the height level H1 of the injection molding machine 301 or at least of the tool 314 so that the sorting device 340 can in particular be arranged above the injection molding machine 301. It is particularly provided that the sorting device at least partially overlaps with the injection molding machine when viewed in a direction perpendicular to the component base area of the injection molding machine 301 (see dashed arrangement in the left representation of FIG. 3). This saves further space. A transport apparatus 342 can realize a feeding of preforms from the sorting device 340 (for example, via an inclined plane and/or an air conveyor) to the first transport device 304. The direction of transport of the preforms in the transport device 342 can be at least partially parallel to a transport of the preforms within the injection molding machine from the tool 314 to the transport device 304 and in particular within the outlet of the injection molding machine.

In order to save further space, it may be provided that a switch 350 is arranged in the injection molding machine 301, or in a transport device leading to the transport device 304, or in the transport device 304, with which switch a feeding of preforms either from the injection molding machine 301 or the sorting device 340 via the transport device 342 to the transport device 304 can be selectively controlled. This control can be realized by the control unit 380 and can, for example, depend on a failure of the injection molding machine.

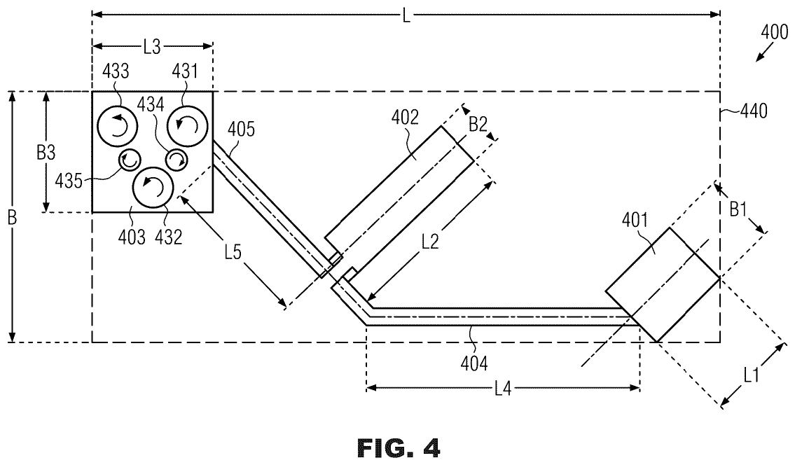

FIG. 4 shows another embodiment of a container processing system. The embodiment shown in FIG. 4 of the container processing system 400 differs from the embodiment of FIG. 2 in that, instead of a single blow molding machine, an aseptic block 403 is provided, which comprises a corresponding fictitious component base area with the side lengths L3 and B3. The aseptic block is shown here as comprising a blow molding machine and at least one further machine, in particular a filler 432 and optionally a further machine, in particular a closer 433.

Transport devices (for example, rotary stars) 334 and 335 can be arranged between these machines. The aseptic block 403 can comprise an aseptic chamber, which, for example, completely or partially seals off a space within the aseptic chamber from the environment so that an exchange of gases is in particular only or optionally substantially only possible through an inlet for containers into the aseptic block and an outlet of containers out of the aseptic block. Within the aseptic chamber (by means of suitable devices such as ventilation devices and temperature control devices), certain requirements in terms of the conditions necessary for processing the containers (in particular producing, filling and closing), such as air humidity, temperature and number of dust particles per cubic meter, can thereby be realized, for example. The use of the container processing system can thus also be realized in the food industry sector and/or in the medical technology sector, wherein a space-saving design is possible at the same time.

In this respect, all embodiments described with reference to FIGS. 2 and 3 apply with the further proviso that the aseptic block 403 replaces the blow molding machine in connection with FIGS. 2 and 3.

1. A container processing system for producing containers from preforms, the container processing system comprising a production machine for producing preforms, a heating device for heating preforms, a blow molding machine for molding preforms into containers, a first transport device for transporting preforms along a first transport direction to the heating device and a second transport device for transporting heated preforms from the heating device to the blow molding machine, wherein the container processing system occupies a fictitious base area in the shape of a rectangle and the production machine, the heating device and the blow molding machine each occupy a fictitious component base area in the shape of a rectangle, wherein a longest side of the base area has a length that is smaller than the sum of the longest sides of the component base areas and the length of the first and the second transport device.

2. The container processing system according to claim 1, wherein the shortest side of the base area has a second length that is smaller than the sum of the shortest sides of the component base areas and the length of the first and the second transport device.

3. The container processing system according to claim 1, wherein an outlet of the production machine encloses an angle between 0° and 90° or between 30° and 60° with the first transport direction.

4. The container processing system according to claim 1, wherein an inlet of the heating device encloses an angle between 0° and 90° or between 30° and 60° with the first transport direction.

5. The container processing system according to claim 1, wherein an outlet of the heating device encloses an angle between 0° and 90° or between 30° and 60° with the second transport direction.

6. The container processing system according to claim 1, wherein the container processing system furthermore comprises a sorting device for removing and aligning preforms from a supply, and wherein the sorting device can feed aligned preforms to an outlet of the production machine, wherein a transport direction of the preforms from the sorting device to the outlet is parallel to a transport direction of preforms within the production machine to the outlet.

7. The container processing system according to claim 6, wherein the sorting device is arranged at a higher height level than the production machine and, when viewed in a direction perpendicular to the component base area of the production machine, is arranged at least partially overlapping with the production machine.

8. The container processing system according to claim 6, wherein a switch, with which a feeding of preforms from the production machine or the sorting device can be controlled, is arranged upstream of the outlet.

9. The container processing system according to claim 1, wherein the production machine comprises an inspection device for inspecting preforms.

10. The container processing system according to claim 9, wherein the production machine comprises a removal device for removing produced preforms from a tool of the production machine, and wherein the removal device can feed the preforms to an outlet of the production machine, or to the first transport device, or to a receptacle depending on an inspection result.

11. A container processing system for producing containers from preforms, the container processing system comprising a production machine for producing preforms, a heating device for heating preforms, an aseptic block for aseptically producing containers from the preforms and for aseptically filling and closing containers, a first transport device for transporting preforms along a first transport direction to the heating device and a second transport device for transporting heated preforms from the heating device to the aseptic block, wherein the container processing system occupies a fictitious base area in the shape of a rectangle and the production machine, the heating device and the aseptic block each occupy a fictitious component base area in the shape of a rectangle, wherein a longest side of the base area has a length that is smaller than the sum of the longest sides of the component base areas and the length of the first and the second transport device.

12. The container processing system according to claim 11, wherein the aseptic block comprises an aseptic chamber and a blow molding machine arranged therein for forming the preforms into containers, a filling machine arranged downstream of the blow molding machine for filling the containers, and a closer arranged downstream of the filling machine for closing the containers.

13. The container processing system according to claim 11, wherein the shortest side of the base area has a second length that is smaller than the sum of the shortest sides of the component base areas and the length of the first and the second transport device.

14. The container processing system according to claim 11, wherein an outlet of the production machine encloses an angle between 0° and 90° or between 30° and 60° with the first transport direction.

15. The container processing system according to claim 11, wherein an inlet of the heating device encloses an angle between 0° and 90° or between 30° and 60° with the first transport direction.

16. The container processing system according to claim 11, wherein an outlet of the heating device encloses an angle between 0° and 90° or between 30° and 60° with the second transport direction.

17. The container processing system according to claim 11, wherein the container processing system furthermore comprises a sorting device for removing and aligning preforms from a supply, and wherein the sorting device can feed aligned preforms to an outlet of the production machine, wherein a transport direction of the preforms from the sorting device to the outlet is parallel to a transport direction of preforms within the production machine to the outlet.

18. The container processing system according to claim 17, wherein the sorting device is arranged at a higher height level than the production machine and, when viewed in a direction perpendicular to the component base area of the production machine, is arranged at least partially overlapping with the production machine.
